(19) United States
(12) Patent Application Publication
(10) Pub. No.: US 2017/0211937 A1
(43) Pub. Date: Jul. 27, 2017

(54) Indoor Positioning System with Fast Plan Mapping

(71) Applicant: NEC Laboratories America, Inc., Princeton, NJ (US)

(72) Inventors: Junqiang Hu, Davis, CA (US); Ting Wang, West Windsor, NJ (US)

(21) Appl. No.: 15/403,615

(22) Filed: Jan. 11, 2017

Related U.S. Application Data
(60) Provisional application No. 62/286,030, filed on Jan. 22, 2016.

(51) Int. Cl. G01C 21/00; G01S 5/02; G01C 21/20

(52) U.S. Cl. CPC G01C 21/005; G01C 21/206; G01S 5/0289

(57) ABSTRACT

An in-door positioning system for a building includes three or more external positioning devices (EPDs), wherein the EPD is capable of calculating the distance between each other; a floor plan module with a floor plan map of the building, for a building level of interest; and relative positions of the EPDs; and an indoor positioning device positioned at a predetermined distance to each of the EPDs.

### BACKGROUND

The system relates to an indoor positioning system with fast floor plan mapping.

Indoor positioning is a common problem people encounter. Due to poor visibility, GPS cannot be used in most indoor applications. Although the industry has developed alternative methods such as using Wi-Fi or Bluetooth triangulation, they usually need a pre-setup or even a survey procedure before being useable. Another problem arises from a building's floor plan. Most commonly, a building's floor plan is a picture image, such as paper copy or microfilm or digitized picture. Even if a positioning system is able to calculate the location of a particular point inside the building, due to the lack of detailed information from the floor plan image, the system may not be possible or hard to map the location into the floor map. However, the capability of such mapping may be critical such as in a fire fighting case, in that such mapping could help the fire fighter to quickly get into the scene or assist the evacuation.

One conventional solution is the method used by Google Map, and the second is that used by indoor positioning software using Wi-Fi or Bluetooth. For Google Map floor plan mapping, the user first find the building on Google Map, then upload the floor plan image (for example in JPEG format), followed by the step of “line up”, to line up the floor plan with Google Map. “Line up” requires many manual operations, and the result may not be accurate.

For existing survey-based indoor positioning system using Wi-Fi or Bluetooth, the procedure is to upload the floor plan, and then specify the positioning node (i.e., the fixed node either to send out signal to or receive signal from the mobile devices to be located) location on the floor plan. This method requires pre-knowledge or pre-processing before usable. An alternative approach is called “opportunistic” solution, which knows its initial location (e.g., from GPS while moving from outdoor to indoor) is to “estimate” the location by measuring a user's acceleration and orientation. This solution requires pre-aligned map (floor plan) with outside image or absolute coordinates which may not be available.

### SUMMARY

In one aspect, an in-door positioning system for a building includes three or more external positioning devices (EPDs), wherein the EPD is capable of calculating the distance between each other; a floor plan module with a floor plan map of the building, for a building level of interest; and relative positions of the EPDs; and an indoor positioning device positioned at a predetermined distance to each of the EPDs.

In another aspect, a positioning system contains 3 or more external devices that are able to synchronize and calculate a relative distance to each other. Each external device also has the capability to measure its distance to the building, such as using ultrasonic or laser distance sensor. The system has software to collect such measured or calculated information, including the distance among the external devices and the distance of each device to the building, and construct 3D model to display through graphic user interface (GUI). The system has code that recognizes the building's floor plan, either in scanned image or architect's design file. The floor plan has dimension between two points, either direct or indirect, that the code can detect. The system is able to display the floor plan using the same scale as the measured distances by external devices and display through the GUI. The user specifies the measuring points at the building or align the floor plan with the drawn outline from the measured distances. The system has indoor device that can be located using external devices' coordination. The indoor device is displayed by software together with floor map. A graphical user interface (GUI) is able to show the overlapped indoor device and the floor map, which gives the indoor device positioning on the floor map.

Advantages of the system may include one or more of the following. The system makes in-field positioning possible, which is able to quickly and accurately display the positioned indoor object or person over the given floor map, without pre-setup or measurement. This is particularly useful under emergent circumstances such as disaster evacuation and firefighting. The system provides the capability of positioning an indoor device without pre-setup and survey, and using devices outside the building to achieve positioning, which may be useful for disaster evacuation and assistance or firefighting.

### BRIEF DESCRIPTION OF THE DRAWINGS

FIG. 1 shows an exemplary positioning system with outdoor and indoor positioning devices and a processing system.

FIG. 2 shows an exemplary EPD in same level as the floor of interest, while FIG. 3 shows the case where the EPDs and the floor of interest not on the same level.

FIG. 4 shows an exemplary floor plan with given orientation, and orientation input example using an exemplary GUI.

FIG. 5 shows an exemplary floor plan map and EPDs displayed in the same scale and orientation.

FIG. 6 shows an example of a fully aligned and overlaid floor plan map and EPDs.

FIG. 7 shows an exemplary alignment when EPD-to-building distance measurement differs from a floor of interest.

FIG. 8 shows an exemplary system with an indoor positioning device (IPD) and its positioning counterparts EPDs.

FIG. 9 shows an exemplary computing system in FIG. 1.

### DESCRIPTION

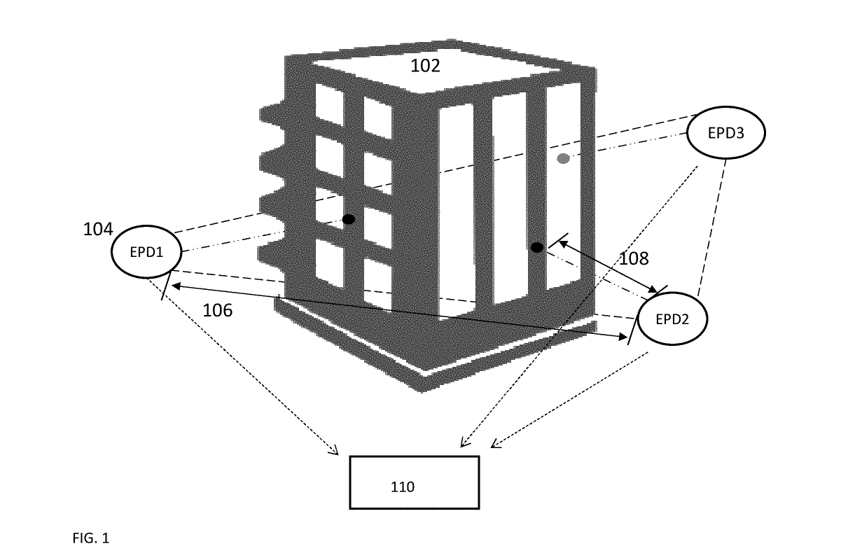

FIG. 1 shows an exemplary positioning system with external positioning devices, a distance measurement module, and a computer 110 in communication with the devices for processing. One embodiment of the system is an indoor positioning system that contains 3 or more external positioning devices (EPD), one or more indoor positioning devices (IPDs), and a computer with code to calculate a relative position of the IPD(s) and EPDs. In one embodiment, the software is running on a computer that has communication channel to the indoor and/or outdoor devices, to receive and/or calculate the relative position.

The EPDs can be human carried or vehicle (including unmanned aerial vehicle or UAV) mounted. The initial step is putting EPDs in fixed positions outside the building, such as EPD1˜EPD4 (each denoted 104) in FIG. 1 outside of building 102. Each EPD 104 has a transmitter and receiver, capable of synchronizing with each other and calculating the relative distance, such as distance 106 between EPD1 and EPD2. In one embodiment, the EPDs 104 know their elevation; in one embodiment, EPDs 104 are put at the same floor level as that of interest. Each EPD 104 has a distance measuring module to measure its shortest distance to the building, such as distance 108 measured by EPD2. An EPD 104 measures both its relative distance to the other EPDs 104 and its distance to the building. These distances are collected by software in device 110. Device 110 can be a computer on the scene, or a portable device inside the building, or a device on the cloud.

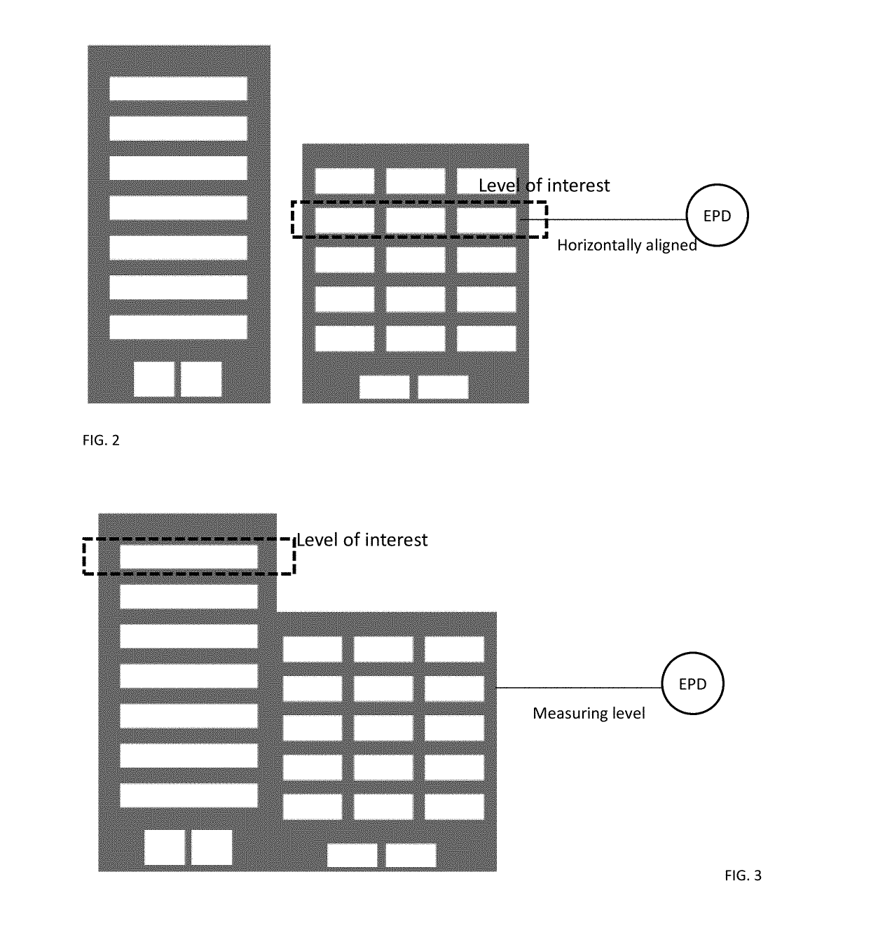

Software on the device 110 maps the relative location of the EPDs 104 and their distances to the building in a planar graph. In addition, the software has the building's floor plan. In one embodiment, the measured distances to the building can be applied directly to the level of interest. For example, the EPD is on the same floor level as that of interest, as shown in FIG. 2. In one embodiment, the distance is adjusted by the difference between measuring level and level of interest, as shown in FIG. 3. Such difference can be calculated from the number given in the floor plans of the different levels. Alternatively, the software generates the outline of measuring level corresponding to the particular EPD, and marks, e.g., using dashed line (either automatically or manually), on the floor map of interest.

FIG. 2 shows an exemplary EPD in same level as the floor of interest, while FIG. 3 shows the case where the EPDs and the floor of interest not on the same level.

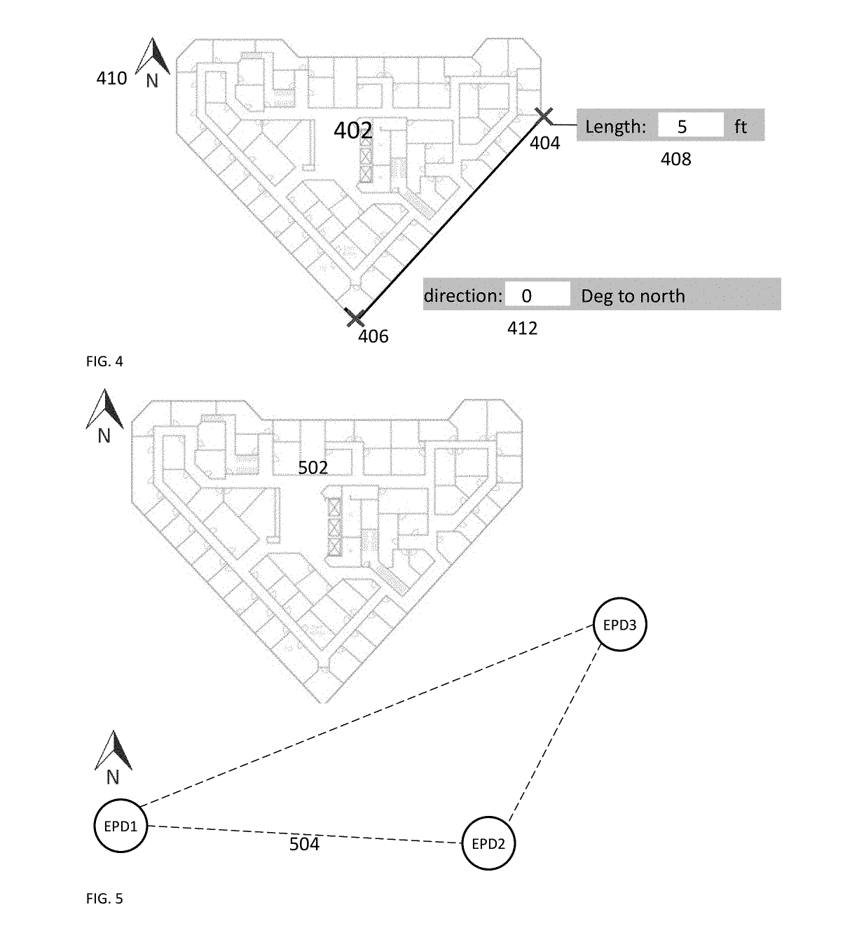

FIG. 4 shows an exemplary floor plan with given orientation, and orientation input example using an exemplary GUI. In this embodiment, the floor plan is given by image, such as scanned JPEG file. This given floor plan includes dimension (either direct or indirect). The software GUI takes two user specified points on the displayed floor plan, together with the actual distance in between. For example in FIG. 4, in software displayed floor plan 402, on which the user specifies two points such as 404 and 406, and the corresponding distance 408 in between. With such input, the software changes the floor plan to the same scale as the positioning devices. In one embodiment, the floor plan is inputted in architect's CAD file format and can be recognized by the software. The software extracts necessary information from the CAD file and displays the floor plan and positioning devices using the same scale.

Besides consistent scale between the displayed floor plan and positioning devices, the software can also have them oriented in the same direction. In one embodiment, one EPD knows the direction of another EPD, and the floor plan has also has the orientation knowledge, either inputted by user (such as input box 412 in FIG. 4) or by extracting data from design file. With such information the software automatically rotates either floor plan or EPD devices (by keeping their relative position fixed) or both to have consistent orientation. One example result after such rotation is given in FIG. 5, where the relative positions of the EPDs are from their measurement; the distances among the EPDs (such as distance 504 between EPD1 and EPD2) are of the same scale as the floor plan 502; the EPDs and the floor plan have the same orientation.

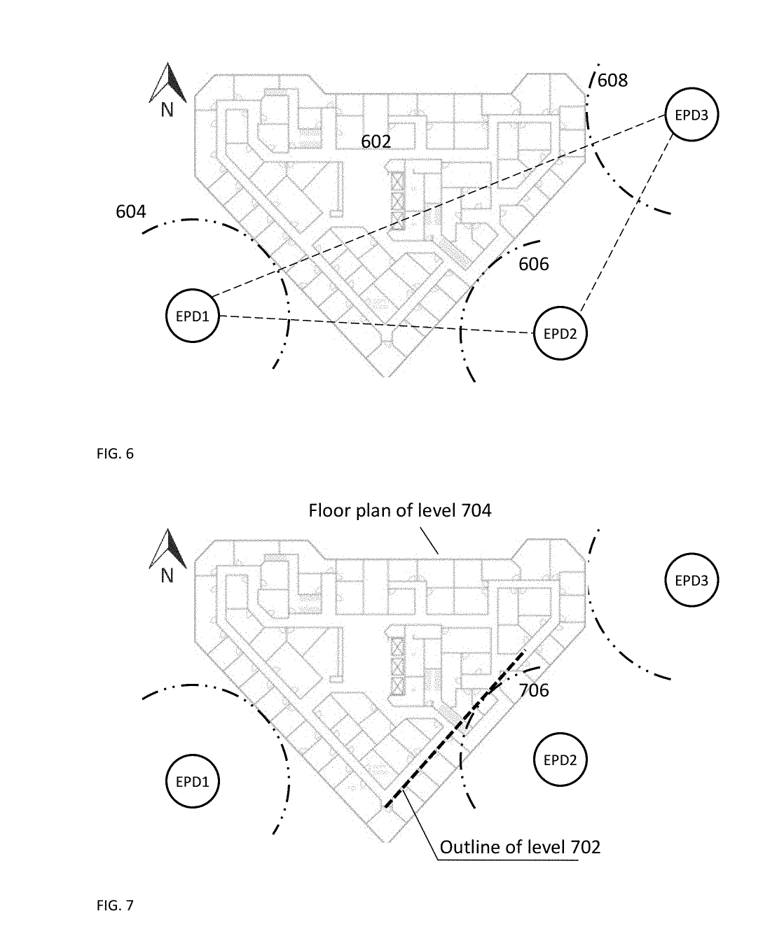

With properly rotated EPDs and floor plan, the next step is combining them to the right relative position. In one embodiment, an assistant circle, for example circle 604 around EPD1, is drawn around each EPD, using measured shortest distance to the building (same level as the floor plan) as the radius of the circle. In one embodiment, the user drags the building or the EPDs (“dragging” step, with their relative position fixed) to let all the circles touch but not cross the floor plan, as shown in FIG. 6. In one embodiment, the software GUI may let the user specify the outline of the building corresponding to each EPD, so that the software will have this step done automatically. Such information can also be extracted automatically if the floor plan has the information and can be extracted by software.

FIG. 5 shows an exemplary floor plan map and EPDs displayed in the same scale and orientation, while FIG. 6 shows an example of a fully aligned and overlaid floor plan map and EPDs. FIG. 7 shows an exemplary alignment when EPD-to-building distance measurement differs from a floor of interest. If the distance to the building is measured at a floor other than that of interest, for example as shown in FIG. 7 the distance is to level 702, but the level of interest is level 704, then the circle (such as circle 706 in FIG. 7) shall be aligned with the outline of level 702. In some cases, the orientation of the floor plan or the EPDs or both cannot be extracted. In this case the aforementioned “dragging” step must move both the relative position and rotate the angle to achieve fitting. This step can be done automatically by the software as well if the necessary outline of the floor plan can be recognized (either manually specify or by extracting data from floor plan design file).

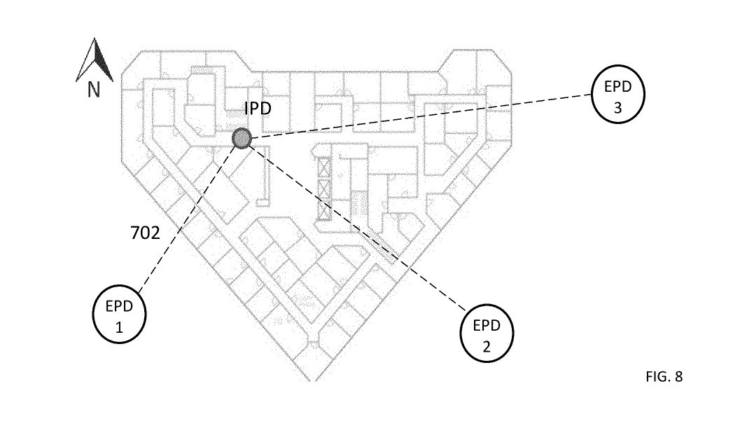

After both the angle and the relative position are aligned, the system considers the combined image as a locked bundle, so that further operation such as rotation or movement will still keep them coupled. Now the software is ready to position the IPD on the floor map. By collecting the distances between an IPD and each EPD, such as distance 702 between IPD and EPD1 in FIG. 8, the software is able to know the relative position of the IPD and display it on the combined image, which achieves visualized positioning. The distance between an IPD and EPD can be obtained by detecting the signal delay from the EPDs to the IPD, or that from the IPD to the EPDs.

FIG. 8 shows an exemplary system with an indoor positioning device (IPD) and its positioning counterparts EPDs. In one embodiment, the aforementioned steps are operated in one device, which is either a computer or mobile device that is independent of, while directly or indirectly (such as in the cloud) talks to, the EPDs and IPD(s). This device publishes the information to other devices of interest, such as another external device, or the IPD. Such publication may contain the position of a particular IPD if necessary. In one embodiment, such device is responsible for aligning the EPDs and the floor plan only, and publishes the aligned picture including the EPDs position to each IPD or relevant devices, then the IPD uses its own collected information (distances to the EPDs) to finish the positioning; for other relevant devices, they may further receive information from the IPDs and finish the positioning.

With these elements and the obtained knowledge, the software:
displays both the EPDs (i.e., their positions relative to each other) and the floor plan over GUI, in the same scale;
rotates the floor plan map and the EPDs' relative position to the same orientation;
aligns the EPDs and the floor plan map to reflect their actual relative position;
positions the IPD on the floor plan map, using obtained distance from that IPD to each of the EPDs.

Various embodiments can include the following:

The EPD has distance sensor, to measure its shortest distance to the building and the distance is measured by acoustic distance sensor, by laser distance sensor, or at the floor of interest

Software uses the measured distance to the floor of interest as radius, to draw a circle around the corresponding EPD; the floor plan map and EPDs alignment includes the procedure to align the outline of the floor of interest with the circles, so that the circles touch but not cross the outline

The distance is measured at a floor that is different from the floor of interest. The outline of the measuring floor is marked on the floor of interest. Software uses the measured distance as radius to draw a circle, and aligns the circle to the outline of the corresponding floor. The EPDs are attached to the exterior of the building. The aforementioned “measured” distances are all zeros. The EPDs are mounted on ground level vehicles; or, the EPDs are carried by UAVs

Software obtains the floor plan scale by letting user specify two points on the floor plan map together with the actual distance in between
Software obtains the floor plan scale by extracting dimension from the floor plan design file
Software has the orientation information for the EPDs and the floor plan map. The rotation is achieved by rotating either the EPDs or the floor plan map by the orientation angle difference
Software lacks the orientation of either the EPDs or the floor plan map or both. The rotation is achieved during the alignment of claims 1.1.3.1 and 1.1.4.1, with procedure of rotating in addition to horizontally-and-vertically movement
The software is running on a third device other than the IPD or EPDs
The software publishes the mapped floor plan and EPDs, including the relative positions of the EPDs to the IPD; the IPD uses its obtained distance to the EPDs to map itself on the floor map
The software is running on the IPD. The IPD uses its obtained distance to the EPDs to map itself on the floor map

In one embodiment, the absolute position and orientation of both the EPDs and the building are known, so the software does the alignment automatically.

The system provides the capability of positioning an indoor device without pre-setup and survey, and using devices outside the building to achieve positioning, which may be useful for disaster evacuation and assistance or firefighting.

The system has 3 or more EPDs, located outside of the building, either portable or vehicle (including UAV) mounted; each EPD has a distance measuring sensor to measure the shortest distance to the building; an indoor positioning device which is the object to map on the corresponding floor plan; software that handles the layout of the EPDs and the floor plan. With these items, the operation procedure is:

1) EPDs measure the distance between each other

2) EPDs measure its shortest distance to the building

3) Software has floor plan image or design file, and the measured data from the EPDs

4) Software obtains dimension of the floor plan, either by user inputting two points and specify the distance, or by reading data from design file; the software zooms the floor plan and the EPDs to the same scale

5) If both the floor plan and the EPDs have orientation information, the software rotates either or the floor plan or the EPDs or both to have them in the same orientation

6) Software aligns the EPDs and the floor plan. This can be achieved by letting user manually drag the floor plan map or the EPDs, or by knowing the outline of the building and using software to automatically do that

7) With IPD distance to each of the EPDs, the software is able to position the IPD on the map.

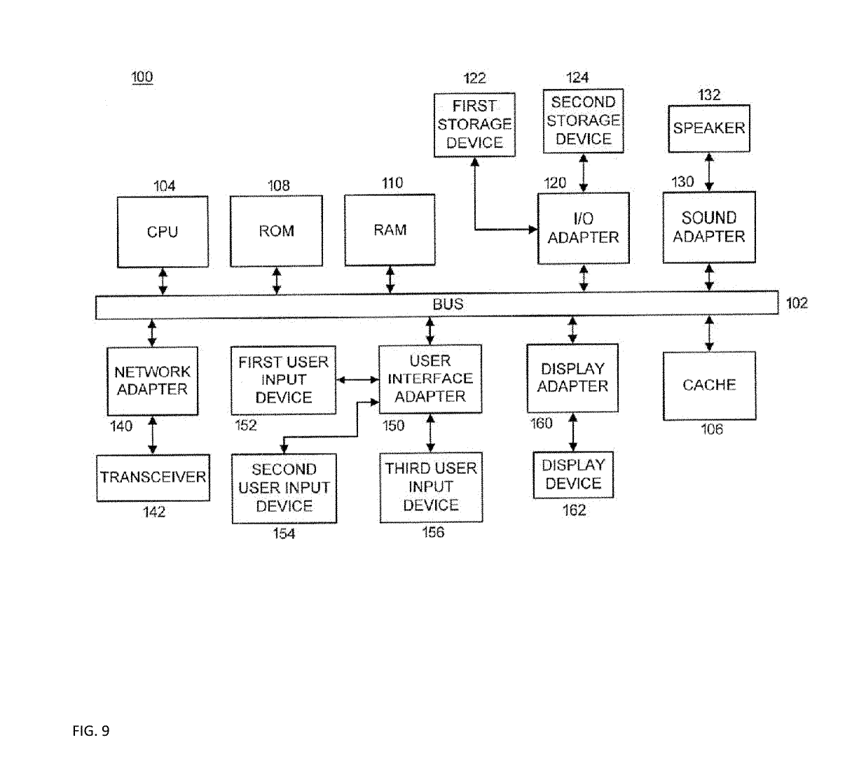

Referring to the drawings in which like numerals represent the same or similar elements and initially to FIG. 9, a block diagram describing an exemplary processing system 100 to which the present principles may be applied is shown, according to an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to a system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to the system bus 102 by the sound adapter 130. A transceiver 142 is operatively coupled to the system bus 102 by a network adapter 140. A display device 162 is operatively coupled to the system bus 102 by a display adapter 160. A first user input device 152, a second user input device 154, and a third user input device 156 are operatively coupled to the system bus 102 by a user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used while maintaining the spirit of the present principles. The user input devices 152, 154, and 156 can be the same type of user input device or different types of user input devices. The user input devices 152, 154, and 156 are used to input and output information to and from the system 100.

Of course, the processing system 100 may also include other elements (not shown), as readily contemplated by one of skill in the art, as well as omit certain elements. For example, various other input devices and/or output devices can be included in the processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations, can also be utilized as readily appreciated by one of ordinary skill in the art. These and other variations of the processing system 100 are readily contemplated by one of ordinary skill in the art given the teachings of the present principles provided herein.

It should be understood that embodiments described herein may be entirely hardware, or may include both hardware and software elements which includes, but is not limited to, firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor, e.g., a hardware processor, coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A building positioner, comprising:
a floor plan module with a floor plan map of a building level of interest and relative positions of at least three external reference devices, each of which is capable of determining a distance between itself and other external reference devices; and
an indoor positioning device in communication with the floor plan module, wherein the floor plan module maps a location of the indoor positioning system relative to locations of the external reference devices.

2. The building positioner of claim 1, wherein the external reference devices comprises external positioning devices (EPDs).

3. The building positioner of claim 1, wherein the module displays external reference device positions relative to each other and the floor plan map using a graphical user interface (GUI), in the same scale.

4. The building positioner of claim 1, wherein the module rotates the floor plan map and each external reference device's relative position to the same orientation.

5. The building positioner of claim 1, wherein the indoor positioning device aligns the external reference device position and the floor plan map to reflect their actual relative position.

6. The building positioner of claim 1, wherein the indoor positioning device comprises three or more external positioning devices (EPDs), wherein the EPD devices are capable of calculating the distance between each other, and the floor plan module includes determining relative positions of the EPDs; and an indoor positioning unit positioned at a predetermined distance to each of the EPDs.

7. The building positioner of claim 6, wherein the module displays EPD positions relative to each other and the floor plan map using a graphical user interface (GUI), in the same scale.

8. The building positioner of claim 6, wherein the module rotates the floor plan map and the EPD's relative position to the same orientation.

9. The building positioner of claim 6, comprising aligns the EPDs and the floor plan map to reflect their actual relative position.

10. The building positioner of claim 6, comprising positions the IPD on the floor plan map, using obtained distance from that IPD to each of the EPDs.

11. The building positioner of claim 1, wherein the distance is measured by an acoustic distance sensor, measured by a laser distance sensor, or measured at a floor of interest.

12. The building positioner of claim 1, wherein the EPD has a distance sensor to measure a shortest distance to the building.

13. The building positioner of claim 1, wherein the module measures a distance to a floor of interest as a radius, draws a circle around each corresponding EPD, and wherein the floor plan map and EPDs alignment includes code to align an outline of a floor of interest with all circles where the circles touch but not cross the outline.

14. The building positioner of claim 1, wherein the distance is measured at a floor that is different from the floor of interest.

15. The building positioner of claim 1, wherein an outline of a measuring floor is marked on a floor of interest and the module a measured distance as a radius to draw a circle, and aligns the circle to the outline of a corresponding floor.

16. The building positioner of claim 1, wherein the EPDs are attached to the exterior of the building.

17. The building positioner of claim 1, wherein the EPDs are mounted on ground level vehicles or carried by UAVs.

18. The building positioner of claim 1, wherein the module obtains a floor plan scale with a user specified two points on the floor plan map together with an actual distance in between.

19. The building positioner of claim 1, wherein the module obtains a floor plan scale by extracting dimension from a floor plan design file.

20. The building positioner of claim 1, wherein the module has orientation information for the EPDs and the floor plan map, wherein rotation is achieved by rotating either the EPDs or the floor plan map by an orientation angle difference.

21. The building positioner of claim 1, wherein the module lacks the orientation of either the EPDs or the floor plan map or both.

22. The building positioner of claim 1, wherein the module rotation is achieved during the alignment and rotating in addition to horizontal-and-vertical movements.

23. The building positioner of claim 1, wherein the module operates on a third device other than the IPD or EPD.

24. The building positioner of claim 1, wherein the module publishes a mapped floor plan and EPDs, including relative positions of the EPDs to the IPD, wherein the IPD uses the determined distance to the EPDs to map itself on the floor map.

25. The building positioner of claim 1, wherein the module runs on the IPD, and the IPD uses its obtained distance to the EPDs to map itself on the floor map.
